(19) United States
(12) Patent Application Publication
(10) Pub. No.: US 2004/0187525 A1
(43) Pub. Date: Sep. 30, 2004

(54) Method and apparatus for making soot

(76) Inventors: Calvin T. Coffey, Watkins Glen, NY (US); Amy L. Rovelstad, Ithaca, NY (US)

Correspondence Address: CORNING INCORPORATED, SP-TI-3-1, CORNING, NY, 14831

(21) Appl. No.: 10/403,149

(22) Filed: Mar. 31, 2003

(51) Int. Cl. C03B 37/075

(52) U.S. Cl. 65/390; 65/425; 65/17.4; 65/441; 65/530; 65/144

(57) ABSTRACT

The present invention relates to a method of making a soot particle and apparatus for making such soot particle. Preferably the method of making the soot particle is substantially free of the step of combusting a fuel and substantially free of the step of forming a plasma. Preferably, the apparatus is devoid of a heating element associated with both combustion and formation of a plasma. A preferred technique for at least one heating step for forming the soot particle is induction heating.

### BACKGROUND OF THE INVENTION

1. Field of the Invention

The present invention relates generally to methods and apparatuses for making optical fiber, and particularly to a method and apparatus for making soot.

2. Technical Background

Optical fibers have acquired an increasingly important role in the field of communications, frequently replacing existing copper wires. This trend has had a significant impact in the local area networks (i.e., for fiber-to-home uses), which have seen a vast increase in the usage of optical fibers. Further increases in the use of optical fibers in local loop telephone and cable TV service are expected, as local fiber networks are established to deliver ever greater volumes of information in the form of data, audio, and video signals to residential and commercial users. In addition, use of optical fibers in home and commercial business environments for internal data, voice, and video communications has begun and is expected to increase.

Optical fibers typically contain a glass core, a glass cladding, and at least two coatings, e.g., a primary (or inner) coating and a secondary (or outer) coating. The primary coating is applied directly to the glass fiber and, when cured, forms a soft, elastic, and compliant material which encapsulates the glass fiber. The primary coating serves as a buffer to cushion and protect the glass fiber core when the fiber is bent, cabled, or spooled. The secondary coating is applied over the primary coating and functions as a tough, protective outer layer that prevents damage to the glass fiber during processing and use.

In at least one technique for making fiber, soot is first deposited to form a soot preform. Various methods have previously been used to make the soot preform, such as outside vapor deposition (“OVD”) and vapor axial deposition (“VAD”). Both OVD and VAD processes typically include a combustion process of an oxygen source and a fuel (e.g., CH₄ or H₂) to form the soot. Burners which have been used in the past to carry out the combustion process include oxygen hydrogen burners, flame hydrolysis burners and atomizing burners. However, these burners all use the aforementioned combustion process to generate the necessary heat to form the soot. A by-product of the aforementioned combustion process is water. The production of water leads to the deposition of soot that includes water. The water in the deposited soot is known to be a source of attenuation in an optical fiber formed in accordance with the aforementioned combustion process. It would be desirable to develop alternative methods for depositing soot.

### SUMMARY OF THE INVENTION

The present invention relates to a method and apparatus for making small particulate material. A first precursor material is contacted either with a second precursor material or oxygen while heating the precursor material and/or oxygen, to a temperature which is less than about 2500° C. but high enough to cause the precursor materials to react and form a particulate having components of both the precursor materials and/or oxygen. The precursor materials are preferably heated via induction heating, most preferably by contacting the precursor materials or mixing the precursor materials within a tube, and heating the tube via induction heating to a temperature which is greater than about 100° C. Such methods are useful, for example, for making optical fiber preforms which can be drawn into an optical fiber. In one preferred embodiment for making optical fiber preforms, the first precursor is a silicon containing precursor and the silicon containing precursor is heated in the presence of oxygen to form silica particles. More preferably, the silica containing precursor and the oxygen are heated together in a tube via induction heating and the silicon as a result reacts with oxygen and forms a silica particle which is emitted from the tube. Preferably, the silica particulate material which is formed in this manner is collected on a substrate. For example, such materials can be collected via collection techniques that are analogous to the collection techniques that are employed in OVD or VAD optical fiber manufacturing processes.

One embodiment of the inventive method of making soot includes heating a silicon precursor to a first temperature of more than about 200° C. in a first chamber. The embodiment also includes heating an oxidizing component to a second temperature of more than about 200° C. in a second chamber. The second chamber is separate and apart from the first chamber. This embodiment of the method further includes combining the heated silicon precursor and the heated oxidizing component to form a mixture. Preferably, the embodiment further includes maintaining the mixture at a third temperature above a temperature associated with an activation energy for the silicon precursor to react with the oxidizing component, wherein a maximum value for the third temperature comprises less than about 2000° C.

A second embodiment of the inventive method includes a step of heating a silicon precursor to at least a first temperature in a first chamber. The first temperature comprises at least a temperature at which silicon of the silicon precursor will react to form silica. Preferably the heating comprises induction heating. The second embodiment of the method further includes heating an oxidizing component to a second temperature in a second chamber. The step of heating the oxidizing component preferably comprises induction heating. The second embodiment of the inventive method also includes mixing the heated silicon precursor and the heated oxidizing component to form a mixture. This embodiment of the method additionally includes maintaining the mixture at a third temperature. The third temperature comprises a temperature sufficient to form the soot particle.

A third embodiment of the inventive method includes heating a silicon precursor to a first temperature. The first temperature comprises a temperature sufficient for the silicon precursor to react to form the soot particle. Preferably the heating of the silicon precursor comprises induction heating. This embodiment also includes mixing the heated silicon precursor with an oxidizing agent to form a mixture and further includes heating the mixture to a second temperature sufficient for the mixture to form the soot particle. Preferably, the heating of the mixture comprises induction heating. Optionally, the first and second temperatures of this embodiment of the invention may be the same or different temperatures.

A fourth embodiment of the inventive method comprises heating a mixture of a silicon precursor and an oxidizing agent to a temperature of more than about 200° C. and less than about 2000° C., wherein the heating comprises a substantially combustion free process.

The inventive method of forming a soot particle may be used to form a soot particle having a maximum diameter of about 5-300 nm. Consequently, the methods disclosed herein may be used to make soot particles having diameter less than 100, and even less than 50 nm. An embodiment of the inventive method that may be used to form the aforementioned soot particle comprises (1) mixing a silicon precursor and an oxidizing agent in a chamber; and (2) applying a sufficient amount of heat to the chamber to form the soot particle, wherein a maximum temperature inside the chamber comprises less than about 2000° C.

In another aspect, the present invention includes an apparatus for making a soot particle. In one embodiment, the apparatus includes a first reactant delivery chamber and a second reactant delivery chamber. The apparatus further includes at least one heating element to supply heat to the first and second chambers. The apparatus also includes a mixing chamber aligned to receive at least one reactant from each of the first and second chambers. Preferably, the apparatus additionally includes a formation chamber extending from the mixing chamber and a formation chamber heating element.

A second embodiment of the inventive apparatus comprises a first reactant delivery chamber and a second reactant delivery chamber. The second embodiment also includes a mixing chamber aligned to receive at least one reactant from each of the first and second chambers. The second embodiment further includes a formation chamber extending from the mixing chamber; and an induction heating element aligned to heat at least the formation chamber. Optionally, the mixing chamber and the formation chamber may be the same or different chambers.

A third aspect of the invention includes a method of making a soot preform. An embodiment of the inventive method of making a soot preform includes the steps of (1) heating a silicon precursor to a first temperature of less than 2000° C. in a first chamber; (2) heating an oxidizing component to a second temperature of less than 2000° C. in a second chamber, the second chamber is separate and apart from the first chamber; (3) combining the heated silicon precursor and the heated oxidizing component to form a mixture; (4) maintaining the mixture at a third temperature above a temperature associated with an activation energy for the silicon precursor to react with the oxidizing component, wherein the third temperature comprises less than about 2000° C., to form a soot particle; and (5) depositing the soot particle on a starting member.

A second embodiment of the inventive method of forming a soot preform includes mixing a silicon precursor and oxidizing agent. The method also includes inductively heating a mixture of the silicon precursor and the oxidizing agent in a chamber at a temperature at which the mixture forms a silica soot particle. The method further includes depositing the particle on a starting member, wherein the starting member does not form the walls of the chamber.

A fourth aspect of the invention is a method of forming nanoparticles. The method includes the step of heating a first particle forming precursor to a first temperature, in a first chamber. The first temperature comprises up to a temperature associated with an activation energy of the first precursor. The method also includes the step of heating a second precursor in a second chamber apart from the first chamber. The method further includes combining the heated first and second precursors to form a mixture. Additionally, the method includes the step of maintaining the mixture at a third temperature above a temperature associated with an activation energy for the first precursor to react with the second precursor to form a particle. Finally, the method includes the step of controlling the third temperature such that the particle has a size of less than about 100 nm.

Practicing the above embodiment can result in various advantages. One advantage is that the above methods of making a soot particle and the apparatus for making a soot particle can result in the formation of a soot particle with a diameter of about 100 nm or less, or even 50 nm or less. The invention has been used to produce soot particles with a diameter as small as about 10 nm or less, even as small as about 5 nm or less. A soot blank formed of particles with a diameter of about 50 nm or less can have the advantage of having a larger surface area than soot blanks formed by traditional methods. Soot particles with increased surface area have a greater surface area for potential dopants to attach to the soot particle. Thus, one excellent application of the invention is to incorporate the invention into a process for forming a doped soot particle. With respect to doped soot particles, in the case of chlorine, a preform having having up to at least about 2 wt % of chlorine has been made. Also, the doping of the soot particle with chlorine has resulted in an advantageous change in viscosity without detrimentally changing the refractive index of the glass. With respect to fluorine, the invention may be used to produce a soot having a fluorine concentration greater than 3 wt % fluorine, more preferably greater than 7 wt % of fluorine. Using the techniques disclosed herein, concentration of greater than 10 wt % of fluorine has been achieved.

Another advantage of practicing various aspects of the invention include that the soot particle may, if desired, be formed without the combustion of a hydrogen source (e.g., hydrocarbon or hydrogen). Therefore, the soot particle formed can be substantially devoid of any water by-product (H₂, OH, H₂O) or water free soot. Water free is used herein to define a silica soot which has been consolidated into a glass with less than about 10 ppm of water, preferably less than about 5 ppm, more preferably less than about 100 ppb, and most preferably about 10 ppb or less.

Another advantage of not combusting a hydrogen source is that a typical by-product of the combustion of a hydrogen source, e.g., hydrocarbon, is a green-house gas such as carbon monoxide. The invention may be used to minimize, preferably eliminate, the production of such green-houses gases as a by-product of the soot formation process.

By not combusting a hydrogen source, the consolidation drying step may be reduced, preferably eliminated, from the fiber making process. Furthermore with respect to the optical fiber manufacturing process, a soot preform made in accordance with the invention may be consolidated at a lower temperature, for a shorter time period, or both for at least the reason that the soot preform made in accordance with the invention may have smaller pore size in the soot preform and will sinter more rapidly than preforms made by conventional techniques.

Additionally, the temperature of the reactants, e.g., the silicon precursor and oxidizing component may, if desired, be precisely controlled during the formation of the soot particle. This ability to control temperature also includes the ability to control the temperature during initial oxidation of the silicon precursor all the way through to soot formation. A closed loop control system may be added to the inventive apparatus for forming a soot particle to incorporate the advantages of a feedback control loop system into the invention. With a closed loop control system, the temperature exposed to the reactants or the resulting product may be controlled to within about 3° C., preferably about 1° C., and more preferably within about 0.5° C. or less. The temperature profile may also be controlled to vary along the length of the apparatus or with the time the material is within the apparatus.

The ability to control temperature during the formation of the soot particle also enhances the deposition process by maintaining the temperature at a level that does not lead to significantly volatilizing away a desired dopant. One example of this is Ge, by controlling the temperature to a predetermined maximum, the Ge to be added to the soot particle may be maintained at a less volatile state than that of Ge added to a soot particle from a flame hydrolysis process. This will lead to a reduction in the amount of Ge which is undesirably exhausted into the pollution abatement system of the deposition process.

It is believed that the apparatus of the invention may be used to deposit soot onto a starting member at higher rates than traditional soot deposition equipment. One reason for this includes the fact that the soot depositing apparatus of the invention may be aligned within about 12″ or less of the starting member, preferably within about 10″ inches or less, and more preferably within about 5″ or less. The reasons also include the that soot may be generated at lower temperature than traditional soot generating operations. Generating soot at a lower temperature has the advantage of better control over the expansion of process gases as the gases enter a reaction/formation area and therefor minimizes the heating of the target by the soot creation process itself. This will allow for separate controls of the soot creation temperature and the deposition target temperature, which can be used to significantly improve the deposition efficiency. Previously, some deposition processes, such as outside vapor deposition, heated the target significantly, and it was beyond the ability of the process to control the target below a certain temperature. Furthermore, lower flow rates of the reaction gases may be used than in traditional processes, and the geometry of the silica soot and other matter exiting the soot generating apparatus of the invention has a more favorable capture geometry with the starting member than those of traditional processes.

Using the techniques disclosed herein, the amount of unwanted materials in the soot particle formed can be unlimited. The invention has been used to produce a high purity fused silica glass with a concentration of less than about 1 ppb of transition metals.

Because of the lack of combustion, the control of temperature in the resonance time of the soot, another potential advantage of the methods disclosed herein in that doping agents may be introduced and caused to react with the soot particle in a very controlled manner.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a cross-sectional view of an apparatus for making soot in accordance with the invention.

FIG. 2 is a cross-sectional view of chamber 24 of the apparatus in FIG. 1.

FIG. 3 is a cross-sectional view of an alternate apparatus for making soot in accordance with the invention.

FIG. 4 is a cross-sectional view of an alternate embodiment of apparatus illustrated in FIG. 3.

FIG. 5 is a cross-sectional view of an alternate apparatus for making soot in accordance with the invention.

FIG. 6 is a schematic cross sectional view of an embodiment the formation chamber, mixing chamber and purge delivery system of the invention.

FIG. 7 is top view of a purge gas port element of the purge delivery system of the invention.

### DETAILED DESCRIPTION OF THE PREFERRED EMBODIMENTS

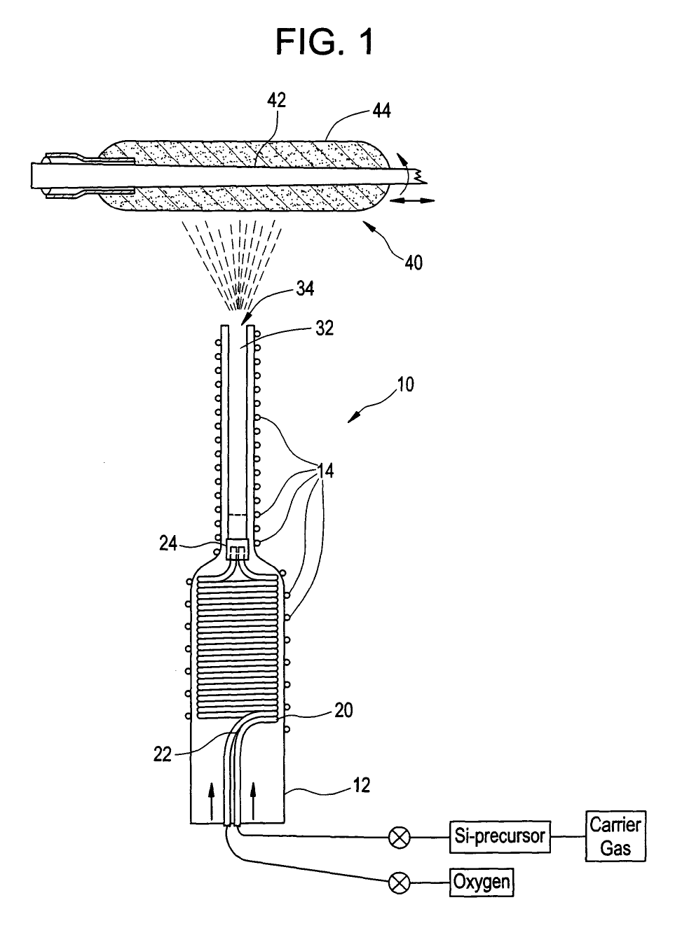

Reference will now be made in detail to the present preferred embodiment(s) of the invention, examples of which are illustrated in the accompanying drawings. Whenever possible, the same reference numerals will be used throughout the drawings to refer to the same or like parts. FIG. 1 illustrates a preferred embodiment of soot gun 10 for making optical fiber preforms.

In the embodiment illustrated in FIG. 1, apparatus 10 includes outer housing 12, around which heating elements 14 are wound. Outer housing 12 is preferably made of fused silica glass, and may be an integral unit or comprised of attached components. Housing 12 is not limited to being made of fused silica, and instead housing 12 may be constructed from other materials. The purpose of housing 12 is to retain the heating elements 14 around a region through which the precursor materials are transported, thereby providing a heat source for the precursor materials. Consequently, housing 12 could be eliminated if the heating elements 14 are sufficiently rigid and alternative means are provided to transport the precursor materials through the heating elements 14.

In the embodiment illustrated in FIGS. 1, heating element 14 is in contact or close proximity to exterior surface of housing 12. The heating element 14 shown in FIG. 1 is an induction coil which shown to be wrapped around housing 12. The length of heating element 14 and the orientation of heating element 14 to housing 12 may be adjusted or altered to achieve any desired temperature profile inside housing 12.

Furthermore, heating element 14 may consist of a single induction coil aligned to heat the entire housing 12 or element 14 may consist of more than one heating element. In the case when heating element 14 consists of more than one heating element, each heating element may include its own control unit 16 or the various elements 14 may share the same control unit 16. Element 14 is not limited to an induction coil. The induction heating is just one suitable method to deliver heat to apparatus 10.

Element 14 is preferably constructed from Cu tubing. Optionally a cooling fluid may be passed inside the tubing while a current for the induction heating is being passed through the tubing. The invention is not limited to any particular type of cooling fluid. Suitable cooling fluids include air and water.

In the embodiment illustrated in FIG. 1, first and second reactant chambers 20 and 22 are located in a lower internal section of housing 12. Silicon precursor may be supplied through first chamber 20 and an oxidizing component supplied through second chamber 22. The silicon precursor may be any of the compounds known to be used to form silica, e.g., SiCl₄, Si(NCO)₄, SiBr₄, SiI₄, silanes, and cyclosiloxanes (e.g., octamethylcyclotetrasiloxane). Preferably, the silica precursor supplied to chamber 20 is in the form of a gas. However, the precursor may also be supplied to apparatus 10 in the form of a liquid through a liquid delivery system.

Alternatively, a doping compound may also be supplied through either reactant chamber 20, 22 or apparatus 10 may include a separate dopant supply chamber (not shown) in which the dopant, as described below, is supplied to apparatus 10 in the same manner as the silicon precursor and the oxidizing agent. A carrier gas may be used if desired, for example, to assist supplying the silicon precursor. Suitable carrier gases include a carrier gas that is inert with the reactants, e.g., nitrogen, argon, helium, and combinations thereof. It is also preferred that the silicon precursor in chamber 20 is substantially devoid of an oxygen containing component, such as oxygen, nitrous oxide (N₂O), or ozone. Substantially devoid is used herein to mean less than about 10% of the oxygen component by volume, preferably less than 7%, more preferably less than about 5%, even more preferably less than about 3%, and most preferably no more than trace amounts of oxygen.

Suitable materials of construction for reactant chambers 20 and 22 include platinum, platinum-rhodium alloys (e.g., 80/20 platinum-rhodium), and carbon. Chambers 20 and 22 can be made from any material with suitable heat resistance that does not form a source of contamination of the materials inside chambers 20 and 22.

In the embodiment of the inventive apparatus shown in FIG. 1, a portion of heating element 14 is aligned to supply heat to chambers 20 and 22. Preferably, element 14 is operated under conditions to heat the materials in chambers 20, 22 to at least about 100° C. It is further preferred that at least one of chambers 20 and 22 includes a silicon containing precursor material and the precursor is heated to a temperature that is sufficient to enable the precursor to react with oxygen and form a soot particle. Examples of suitable temperatures to react the precursor include at least about 800° C., more preferably at least about 900° C., even more preferably at least about 1000° C., and most preferably up to about 1750° C.

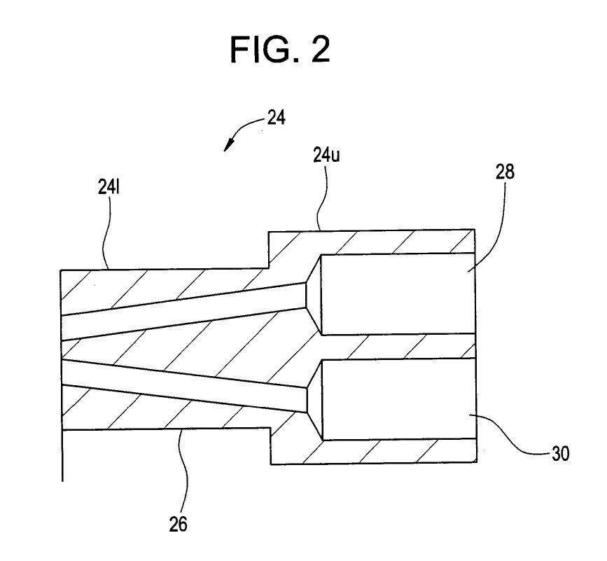

In the embodiment illustrated in FIG. 1, the contents of chambers 20 and 22 are combined in mixing chamber 24. One example of mixing chamber 24, illustrated in FIG. 2, includes a coupling section 26 in which passages 28 and 30 converge towards one another. In one embodiment, each passage 28 and 30 converges toward one another at an angle of about 6°. However, the invention is not limited to passages 28 and 30 converging toward each other at any particular angle or that passages 28 and 30 converge toward one another at all. Preferably, the silicon precursors and oxidizing agent emerge from passages 28 and 30 and contact one another at a temperature which is sufficient to initiate a silica forming reaction.

In one preferred embodiment of chamber 24, an overall length of chamber 24 comprises about 1 inch. The length of a lower section 241 of chamber 24 comprises about 0.5 inches and an upper section 24u of chamber 24 comprises about 0.5 inches. A diameter of 241 comprises about 0.56 inches and a diameter of 24u comprises about 0.39 inches. The entrance diameter of passages 28 and 30 of coupling section 26 comprises about 0.19 inches. Exit diameter of passages 28 and 30 may range from about 0.090 to about 0.060 inches.

Referring again to FIG. 1, apparatus 10 further includes a formation chamber 32 extending from mixing chamber 24. In one embodiment mixing chamber 24 is a portion of formation chamber 32. Alternatively chamber 32 may be different than chamber 24, however, chamber 32 should be aligned in fluid communication with chamber 24. Chamber 32 may be integral or attached to chamber 24. The formation chamber can be formed from the same material as chambers 20 and 22.

At the end of mixing chamber 32 is exit orifice 34. Orifice 34 is not limited to any particular shape. Orifice 34 may be circular, oval, rectangular, etc. Additionally, apparatus 10 further includes a formation chamber heating element. The formation chamber heating element may preferably be a portion of element 14 aligned to supply heat to chamber 32. Preferably, formation chamber heating element 14 comprises an induction coil positioned along at least a portion of an exterior surface of formation chamber 32.

In the embodiment illustrated in FIG. 1, soot gun 10 is aligned so that particles emanating from orifice 34 are emitted towards starter member 40. In the embodiment illustrated, starter member 40 is comprised of a bait rod or mandrel 42 and a quantity of silica containing soot that has already been deposited over bait rod 42. Preferably, during the deposition step, bait rod 42 is rotated and either the soot gun 10 or the starting member 40 is reciprocated back and forth with respect to one another so that a uniform coating is applied to the starting member 40. Exit orifice 34 is preferably located within about 15 inches of starting member 40, preferably within about 12 inches from starting member 40, more preferably within about 10 inches of starting member 40, and most preferably within about 6 inches of starting member 40.

In one preferred embodiment of formation chamber 32, chamber 32 includes at least one dopant port. The dopant part may be located at any point along the length of chamber 32. One advantage of adding the dopant into chamber 32 instead of as previously discussed is that this embodiment will allow the dopant to be introduced into a soot particle after the soot particle has formed and reached a predetermined size. The dopant may be introduced into the soot particle at a certain temperature that is advantageous for doping the soot particle with the dopant. For example, it is believed that it is advantageous to dope silica soot with fluorine while the soot has a sufficiently large surface area to avoid being completely etched by the fluorine. By introducing the fluorine doping precursor into apparatus 10 after mixing chamber 24, the fluorine doping compounds can be introduced to the soot at an optimum point, e.g., once the soot particle has a surface area of about 20 m²/g or more.

This would also eliminate the need to take into account to what extent the soot formation reaction was either exothermic or endothermic with respect to doping the soot preform. For example if the formation of a soot particle from a silicon halogen precursor is an endothermic reaction, doping the soot particle at the same temperature at which the soot particle was formed would require additional heat to be added to the reaction chamber.

Soot gun 10 may further include a purge system to prevent deposition of matter on an internal wall of formation chamber 32. In one example of the purge system, the formation chamber includes one or more ports for which inert gas may be injected into chamber 32. Examples of suitable inert gases include N₂, Ar, He, and combinations thereof. A function of the inert gas is to inhibit the soot particles being formed from moving in a radial direction and depositing on an inner surface of chamber 32, preferably preventing deposition of the soot on the inner surface. The purge system may also assist in the axial movement of the soot particle being formed.

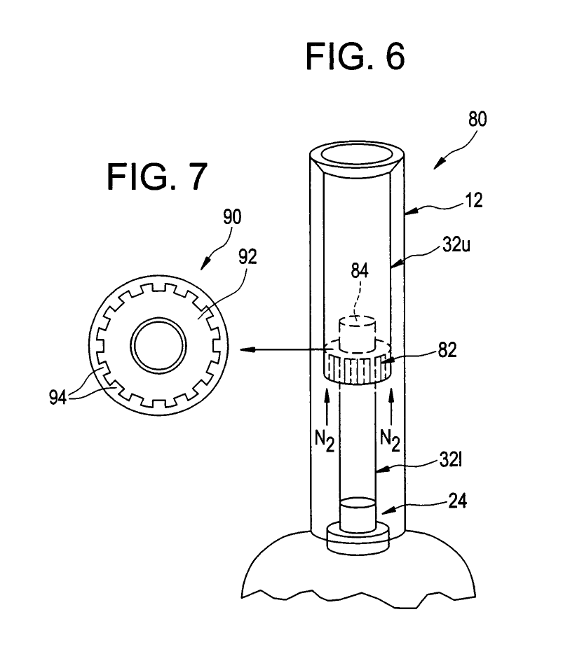

One embodiment of the purge system is shown in greater detail in FIGS. 6 and 7. FIG. 6 is a schematic cross sectional view of a top half of apparatus 10, generally designated 80. Illustrated in FIG. 6 is mixing chamber 24 attached to a lower section 321 of formation chamber 32 and an upper section 32u of formation chamber 32. A purge port 82 extends from a top end of lower section 321. Purge port 82 includes a central passageway 84, in which the reactant gases and reaction products flow from lower section 321 into lower section 32u. Preferably, purge port 82 is constructed from the same material as sections 321 and 32u of the formation chamber. One preferred material of construction comprises platinum-rhodium.

Purge port 82 also includes a plurality of passages 94 along an outer region of port 82. Passages 94 are preferably equally spaced around port 82, as close together as possible so that the number of passages 94 is maximized. It is additionally preferred that passages 94 are located as close to the periphery of port 82 as possible. In an alternate embodiment, passages 94 may comprise notches along the circumference of part 82 or some combination of notches and passages.

Preferably, the inert purge gas is flowed into a bottom opening of housing 12 and up through passages 94 of port 82 into section 32u of chamber 32. It is further preferred that the inert gas is flown into housing 12 under a condition such that the flow of the gas in section 32u comprises laminar flow.

In one alternate embodiment of heating element 14, heating element 14 to supply heat to first and second chambers 20 and 22 comprises at least one induction coil aligned with at least a portion of an exterior surface of first chamber 20 and at least a second induction coil positioned aligned with at least a portion of an exterior surface of second chamber 22.

Optionally, apparatus 10 may include a first reactant delivery chamber heating element. The first reactant delivery heating element may be aligned to heat first chamber 20. The first reactant delivery heating element may be an integral part or separate from induction heating element 14. The apparatus 10 may also include a second reactant delivery chamber heating element. The second reactant delivery heating element may be aligned to heat second chamber 22. The second reactant delivery heating element may be an integral part or separate from induction heating element 14. In one alternate embodiment, the first reactant delivery chamber heating element and the second reactant delivery chamber heating element comprise the same heating element. In another embodiment, the first reactant delivery chamber heating element and the second reactant delivery chamber heating element comprise more than one induction heating element.

Additionally, apparatus 10 may include one or more auxiliary heaters. For example, auxiliary heaters could be provided in the form of clamshell induction heaters positioned around the exit orifice of the apparatus 10 to further heat the soot as it exits from apparatus 10. A purpose of the heaters is to assist in controlling the density of a soot preform formed from the soot generated from apparatus 10.

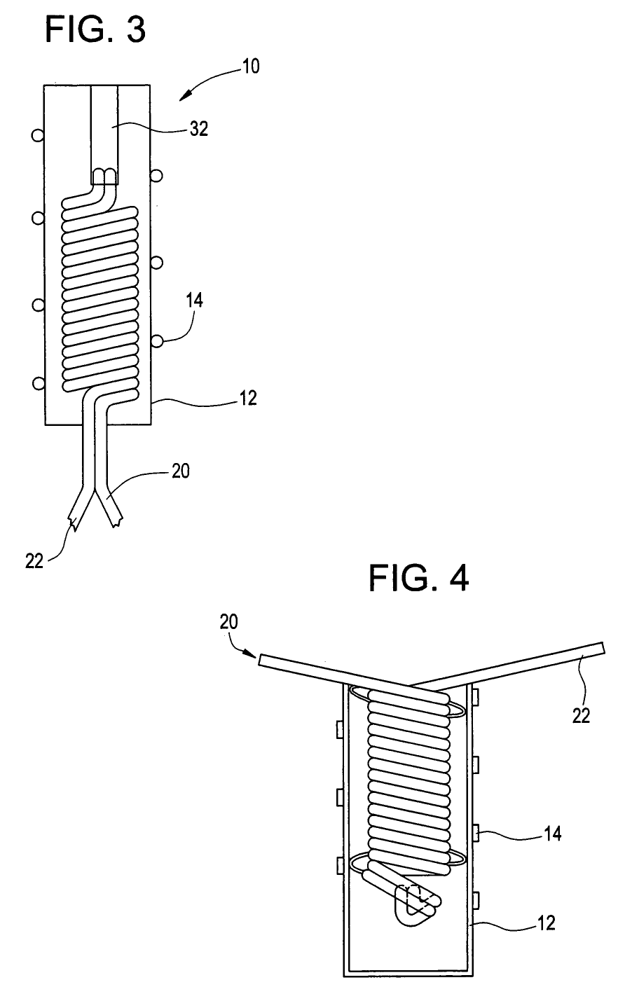

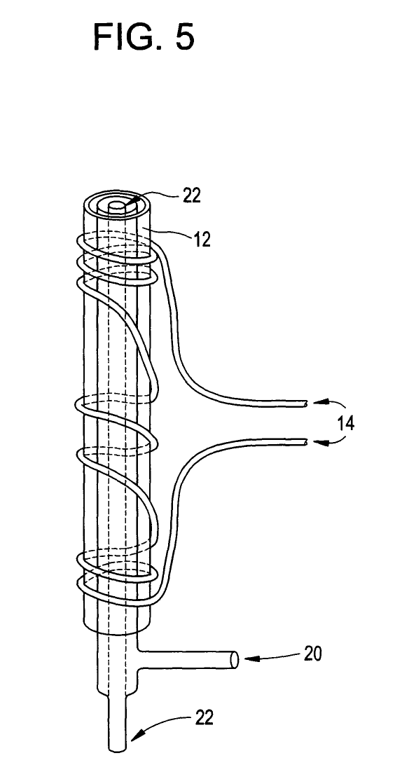

Various embodiments of chambers 20 and 22 are depicted in FIGS. 3-5. Illustrated in FIG. 3 is an embodiment wherein chambers 20 and 22 are coiled together vertically upward and connected to mixing chamber 24. Note that mixing chamber 24 has been omitted, as mixing chamber 24 is not essential to carrying out the invention. In FIG. 4, chambers 20 and 22 are coiled vertically downward although the exit orifices of chambers 20 and 22 are directed upwardly back through the coiled regions. As shown in FIG. 5, chambers 20 and 22 are aligned coaxially. In the embodiment depicted, chamber 22 is outside of chamber 20.

The orientation of chambers 20 and 22 is not limited to the depicted embodiments, and virtually any of a multitude of variations can be employed to heat the precursor materials to the desired temperatures, e.g., other embodiments could be employed wherein the precursor materials are transported through an induction coil to be heated to a temperature sufficient to cause the precursor materials to react and form a soot. Various other configurations are within the scope of the invention.

Another aspect of the invention relates to a method of making a soot particle. A soot particle is defined herein to mean an unconsolidated or consolidated glass particle. Depending upon the temperature which is selected to produce the soot particle, the soot particle may be a fully or partially consolidated glass particle. In accordance with one embodiment for making a soot particle, a silicon precursor is first heated to a first temperature of more than about 200° C. in a first chamber. The method includes another step of heating an oxidizing component to a second temperature of more than about 200° C. in a second chamber. The second chamber is preferably separate and apart from the first chamber. The first and second temperatures may be the same temperature or different temperatures. Examples of a suitable first temperature include more than about 100° C., at least about 800° C., at least about 900° C., at least about 1000° C., and no more than about 1750° C. Preferably, the second temperature is also in the same range of the first temperature of at least about 100° C. to no more than about 1750° C.

Preferably, this embodiment of the method also includes the step of combining the heated silicon precursor and the heated oxidizing component to form a mixture. The method preferably further includes maintaining the mixture at a third temperature above a temperature associated with an activation energy for the silicon precursor to react with the oxidizing component, wherein a maximum value for the third temperature comprises less than about 2000° C. Preferably, the third temperature is at least about 1500° C. Activation energy is used herein to mean the minimum energy required for the silicon precursor to react with at least an oxidizing agent to from doped or undoped silica. The step of maintaining is used herein to mean at least maintaining a mixture of reactants at at least an appropriate temperature for a mixture of reactants to react and form a desired reaction product.

With respect to the above embodiment of the inventive method, preferably at least one of the above heating steps comprises heating by induction heating. More preferably, at least two of the above heating steps comprise heating by induction heating. Most preferably induction heating may be used to accomplish all of the heating requirements of the above embodiment of the inventive method.

Optionally, each induction heating step may be separately controlled or any combination of heating steps may be jointly controlled. An example of jointly controlled is the same control unit is used to control the induction heating of the precursor and the oxidizing agent. Jointly controlled is used herein to define at least the situation when two or more heating steps are controlled by the same control unit.

The embodiment may also include the step of nebulizing (atomizing) at least the silicon precursor. Preferably, such atomizing will occur prior to the mixing of the silicon precursor and the oxidizing agent, more preferably prior to the mixing and the heating of the silicon precursor. The aforementioned step of nebulizing the silicon precursor may be applied to any other embodiment of the inventive method of making a soot particle or methods of making a soot preform disclosed herein.

It is also preferred that the inventive method is substantially free of a step of combusting a fuel. In the course of using induction heating, it is further preferred that the frequency used to create the induction heating is insufficient to substantially form a plasma. Preferably, the frequency used to create the induction heat is less than about 3.5 MHz, more preferably less than about 3.0 MHz, even more preferably less than about 2.5 MHz, and most preferably less than about 2.0 MHz. Examples of a frequency suitable to create required induction heat comprises from about 500 kHz down to about 150 kHz.

Suitable power amounts for providing the induction heating include about 1 to 10 kW, although higher or lower amounts could be employed. Similarly, voltages on the order of about 100 to 300 volts, and currents of about 3 to 20 amps, more preferably about 10-15 amps can be employed, although variations from these ranges could also be used. Preferably, the combination of power and frequency which is employed is not sufficient to form a plasma.

Optionally the silicon precursor may further comprise a dopant. The dopant may comprise a compound having at least one element selected from the group of elements consisting of, F, Br, B, Bi, Cl, I, Ge, Sn, Pb, S, Se, Te, Ga, In, As, P, Sb, Ti, Ta, Al, alkalis (Li, Na, K, Rb, Cs), alkaline earths (Be, Mg, Ca, Sr, Ba), rare earths (Ce, Pr, Nd, Sm, Eu, Gd, Tb, Dy, Ho, Er, Tm, Yb, Lu), transition metals (elements 21-29 (scandium through copper), elements 39-47 (ytterbium through silver), 57-79 (lanthanum through gold), and elements 89 et seq. (actinium through the end of the periodic table). Examples of potential dopant compounds include organometallics (such as alkoxides or “fods”), soluble salts, and combinations thereof. A nonexhuastive list of suitable doping compounds include fluorosilanes, chlorosilanes, trichlorides, POCl₃. CF₄, C₃F₈, and SiF₄. With respect to forming a halide doped glass, the invention may be practiced to incorporate up to at least 1.2 wt % of Cl into a glass formed in accordance with the invention, more preferably up to at least about 2.0 wt %. With respect to F, the invention can be practiced to include at least about 5 wt % of F into the glass, and in fact has been used to achieve 10 wt % of F and even higher.

Preferably, the oxidizing component comprises at least one compound from the group of selected from O₂, nitrous oxide (N₂O), ozone, and combinations thereof. It is believed that the use of nitrous Oxide as the oxidizing agent allows for the soot particle to be formed at lower temperatures than compared to the use of oxygen alone as the oxidizing agent. For example for a reactant flow ratio of 1/2/3/4 (1 slpm N₂ carrier with SiCl₄, 2 slpm O₂, 3 slpm N₂), and 4 slpm N₂ purge) the soot reaction can occur at temperatures of 1230° C. and less. In comparison if the oxidizing agent comprises O₂ alone, the soot formation reaction will occur at temperatures of about 1250° C. and higher. A preferred temperature range in chamber 32 with nitrous oxide oxidizing agent is about 900° C. to about 1230° C., more preferably about 1100° C. to about 1230° C.

A second embodiment of the inventive method of forming a soot particle comprises the step of heating a silicon precursor up to a first temperature in a first chamber. The first temperature comprises at least a temperature at which silicon of the silicon precursor will react to form silica. Preferably, the heating comprises induction heating. Preferably the first temperature comprises at least about a temperature of about 100° C., more preferably at least about 900° C., even more preferably at least about 950° C., and most preferably no more than about 1750° C.

Optionally, this embodiment of the inventive method may include a step of heating an oxidizing component to a second temperature in a second chamber. Preferably, the step of heating the oxidizing component comprises induction heating. The second temperature may be the same temperature as the first temperature or a different temperature. Although, the range of the second temperature is the same as the range of the first temperature as described above.

It is further preferred that the embodiment of the method includes the steps of mixing the heated silicon precursor and the heated oxidizing component to form a mixture and maintaining the mixture at a third temperature. Preferably the third temperature comprises a temperature sufficient for the aforementioned soot particle to form. Furthermore, the step of maintaining may comprise heating a third chamber containing the mixture by induction heating.

The aforementioned description regarding the silicon precursor, dopants, and the oxidizing component regarding the first embodiment of the inventive method also applies to this embodiment of the inventive method and is incorporated herein as fully rewritten.

The inventive method includes a third embodiment for making a soot particle. The third embodiment of the method includes the step of heating a silicon precursor to a first temperature. The first temperature comprises up to a temperature sufficient for the silicon precursor to react to form the soot particle. Preferably the heating of the silicon precursor comprises induction heating. The third embodiment may include the step of mixing the heated silicon precursor with an oxidizing agent to form a mixture. Preferably, the embodiment includes the step of heating the mixture to a second temperature sufficient for the mixture to form the soot particle. It is further preferred that the heating of the mixture comprises induction heating.

A fourth embodiment of the inventive method of forming a soot particle includes forming a soot particle having a maximum diameter of about 50 nm or less. The embodiment of the method includes mixing a silicon precursor and an oxidizing agent in a chamber and applying a sufficient amount of heat to the chamber to form the soot particle. A maximum temperature inside the chamber comprises less than about 2000° C. Preferably, the temperature comprises a temperature of the atmosphere in the chamber. It is also preferred that the temperature is at least about 800° C., more preferably at least about 1000° C., and even more preferably at least about 1500° C.

This embodiment of the inventive method may further include flowing an inert gas through the chamber during the applying step. Optionally it is preferred that the temperature profile along a length of the chamber increases from an entrance of the chamber to an exit of the chamber. Preferably the soot particle exits the chamber at the exit.

Alternatively, the embodiment may include the step of heating the silicon precursor to a temperature of greater than about 700° C. The heating of the silicon precursor, preferably occurs prior to mixing the silicon precursor and the oxidizing agent. Furthermore, the oxidizing agent may be heated to a temperature of greater than about 700° C. The heating of the oxidizing agent also, preferably occurs prior to mixing the silicon precursor and oxidizing agent. Additionally, the aforementioned description regarding the silicon precursor, dopants, and the oxidizing agent applies to this embodiment of the inventive method.

A fifth embodiment of the inventive method comprises heating a mixture of a silicon precursor and an oxidizing agent to a temperature of more than about 200° C. and less than about 200020 C. Preferably, the lower temperature is about 400° C. or more, and more preferably about 600° C. or more, and most preferably about 800° C. or more. Preferably the aforementioned heating comprises induction heating. It is also preferred that this embodiment is substantially free of a combustion step. A combustion step is defined herein as a oxidation reaction which releases heat, but does not result in the formation of a soot particle. Preferably, the mixture comprises substantially devoid of a fuel. A fuel is used herein to mean at least a compound that would combust in an atmosphere which included oxygen however, the combustion of the fuel-compound will not result in the formation of a soot particle. A non-exhaustive list of fuels includes hydrocarbons (e.g., methane, propane, ethane, butane, etc.) and hydrogen. It is further preferred that the embodiment is free of the step of forming a plasma.

The invention further includes an inventive method for forming a soot preform. One embodiment of the inventive method for forming a soot preform includes the step of heating a silicon precursor to a first temperature of less than about 2000° C. in a first chamber. Preferably, the first temperature ranges from about 100° C. to about 1750° C. The embodiment also includes the step of heating an oxidizing component to a second temperature of less than about 2000° C. in a second chamber. Preferably, the second chamber is separate from the first chamber. Also, the second temperature may be the same temperature as the first temperature or a different temperature than the first temperature.

The embodiment of the method may further include the steps of combining the heated silicon precursor and the heated oxidizing component to form a mixture and maintaining the mixture at a third temperature above a temperature associated with an activation energy for the silicon precursor to react with the oxidizing component. The third temperature comprises less than about 2000° C. Preferably, the soot particle formed is deposited on a starting member.

Preferably, the step of maintaining occurs in a third chamber. Optionally the embodiment includes the step of introducing a shield gas through the third chamber to inhibit, preferably prevent, deposition of the soot particle on an inner surface of the third chamber.

Optionally the step of heating at least one of the heating of the silicon precursor, the heating of the oxidizing component, maintaining the mixture, and combinations thereof comprise induction heating. It is further preferred that more than one of the heating steps comprises induction heating. Furthermore, the aforementioned description regarding the silicon precursor, dopants, and the oxidizing component regarding the first embodiment of the inventive method also applies to this embodiment of the inventive method and is incorporated herein as fully rewritten.

A second embodiment of the inventive method for forming a soot preform comprises the steps of mixing the silicon precursor and the oxidizing agent and inductively heating a mixture of the silicon precursor and the oxidizing agent in a chamber to a temperature sufficient for the mixture to form a silica soot particle. The embodiment of the method also includes depositing the particle on a starting member. Preferably the starting member does not comprise a wall of the chamber. It is also preferred that the mixture comprises substantially devoid of a fuel. It is further preferred that a maximum temperature inside the chamber comprises less than about 2000° C.

This embodiment of the inventive method may further comprise heating the silicon precursor a temperature of at least about 100° C. prior to the step of mixing. It is also preferred that the step of heating of the silicon precursor comprises induction heating. Optionally, the embodiment may also further include heating the oxidizing agent to a temperature of at least about 100° C. prior to the step of mixing. Preferably the heating of the oxidizing agent comprises induction heating. It is also preferred that an atmosphere within said chamber comprises substantially devoid of a plasma.

As stated above for silica soot formed in accordance with the invention may be used to form soot preforms for manufacturing optical products such a optical fiber, high purity fused silica lens, and planar substrates. The silica soot may also be used for polishing high purity fused silica lens. The silica soot is a polish that would not contaminate the surface of the lens.

In addition to making soot particles, the invention may be used to manufacturing nanoparticles. The nanoparticles may be soot based or based on another material, e.g., germanium, titanium, aluminum, etc. A nanoparticle is used herein to define a particle with a maximum diameter of less than about 150 nm. The invention may be practiced to produce particles with a diameter of no more than about 100 nm, preferably no more than about 75 nm, more preferably no more than about 50 nm, even more preferably no more than about 25 nm, and most preferably no more than about 10 nm.

One inventive method of forming nanoparticles, that is part of the invention, includes the step of heating a first particle forming precursor to a first temperature in a first chamber. Preferably the first temperature comprises up to a temperature associated with an activation energy of the first precursor. It is also preferred that the first temperature comprises at least about 100° C. The method further includes heating a second precursor in a second chamber apart from the first chamber. Preferably the second precursor is heated to a temperature at least equal to the first temperature. The method also includes the steps of combining the heated first and second precursors to form a mixture and maintaining the mixture at a third temperature above a temperature associated with an activation energy for the first precursor to react with the second precursor to form a particle. Lastly, the method includes the step of controlling the third temperature such that the particle has a size of about less than 100 nm.

The above nanoparticles are not limited to silica soot nanoparticles. The particles may be made of any type of oxide or mixed oxide-halides. Also, the nanoparticle may be doped in the same manner as described above. The inventive method and apparatus is not limited to only the embodiments cited above.

Various embodiments of the operation of apparatus 10 are described above. In each embodiment, the silicon precursor comprises SiCl₄. Typically a bubbler, operating at about 40° C., and a carrier gas is used to introduce the silicon precursor into apparatus 10.

As for the embodiment of apparatus 10 is preferably as shown in FIG. 1. Heating element 14 provides heat to all three of chambers 20, 22, and 32. An Ameritherm Induction Heater was used to provide the necessary heating for the reaction of the silicon precursor and the oxidizing agent. N₂ gas was used as a purge gas and passed through purge port 82 at a rate of about 4 slpm.

Each one of chambers 20, 22, and 32 was heated to about 1300° C. The power for the induction heating of chamber 32 was about 3.4 kwatts. The settings for the induction heater was a frequency of about 208 kHz, voltage of about 290 volts, and about 13 amps. The power of the system was about 3.4 kW. An optical pyrometer was used to determine the temperature of chamber 32 and to monitor that the temperature maintained at 1300° C.

The starting member was about a ⅜″ bait rod, rotating at a speed of about 0.75 cm/s. An exit orifice of apparatus 10 was about 3″ from the center of the starting member. Apparatus 10 traversed along the length of the starting member at a rate of about 0.75 m/s.

The rate of flow of the silicon into apparatus is provided in terms of the carrier gas (N₂) in slpm. In a first embodiment, SiCl₄ with an N₂ carrier gas is introduced into chamber 20 at a rate of about 2.0 slpm. An oxidizing agent of about 2.0 slpm of O₂ and about 4 slpm of N₂O is introduced into chamber 22. Apparatus 10 was operated for about 3 hours and about 8 grams of silica soot was collected on the starting member.

In a second embodiment of the operation of apparatus 10, apparatus 10 is operated at a temperature of about 1100° C. The reactant gases (N₂ (carrier gas) with SiCl₄/O₂/N₂O) were supplied at a ratio of about 1:2:3 to apparatus 10. All other parameters were the same as the first operational embodiment of apparatus 10.

In a third embodiment, the reactant gases (N₂ (carrier gas) with SiCl₄/O₂/N₂O) were supplied at a ratio of about 1:2:3.5 to apparatus 10 and the temperature was about 1010° C. In this embodiment of apparatus 10, the diameter of passages 28 and 30 was about 0.060″ instead of about 0.090″ as in the first two operational embodiments.

The soot making apparatus disclosed herein can be used in a variety of CVD techniques used to make optical fiber. For example, in addition to the outside vapor deposition (OVD) technique illustrated in FIG. 1, the apparatus could also be employed in a vapor axial deposition (VAD) format. Alternatively, the apparatus illustrated in any of the figures above could be used to deposit soot or glass in an inside deposition (IV) process. For example the soot making apparatus could be positioned at one end of a rotating silica tube, and soot particles emitted from the soot making apparatus could be directed into the tube. If desired, a heat source could be provided outside the tube to traverse the length of the tube and thereby allow the soot to condense and/or consolidate on the inside of the tube via thermophoresis. On completion of soot deposition step, consolidation could occur via a number of ways, e.g., removal of the silica tube and soot and consolidating in a furnace, or using the outside heat source to traverse the tube and consolidate the deposited material and optionally close any remaining centerline hole.

### EXAMPLES

The invention will be further clarified by the following examples.

### Example 1

Soot Particle Size

In this example, the particle size of soot particles made in accordance with the invention were compared to soot particles formed from a VAD soot deposition process. The size of each soot particle, in terms of diameter was determined by use of scanning electron microscopy (“SEM”). The embodiment of apparatus 10 was the same as shown in FIG. 1 along with the purge system of FIGS. 6 and 7. Apparatus 10 was used in the same manner as the above operational embodiments except any below noted details.

For example, a reactant ratio of about 1:2:0 resulted in soot particles collected which ranged from about 50 nm to about 100 nm. A reactant ratio of about 2:2:0 and an operating temperature of about 1557° C. resulted in soot particles of about 40 nm to about 60 nm. A reactant ratio of about 1:1:0 and an operating temperature of about 1570° C. resulted in soot particles having a diameter of about 100 nm to about 300 nm. A reactant ratio of about 1:2:3 and an operating temperature of about 1115° C. resulted in soot particles of about 10-15 nm diameter. The above example illustrates that the may be used to produce smaller soot particles than conventional methods of manufacturing soot.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of forming a particle comprising:
contacting a first precursor material with a second precursor material while heating said first and second materials via induction heating to a temperature less than about 2500 C but high enough to cause said precursor materials to react and form a particle having components of both precursor materials.

2. The method of claim 1, wherein said contacting step comprises contacting said precursor materials within a tube, and said tube is heated via said induction heating to a temperature greater than about 100 C.

3. A method for making silica in accordance with claim 1, wherein said first precursor is a silicon containing precursor, said second precursor is an oxygen containing precursor, and said precursor materials react to form silica particles.

4. A method for making silica in accordance with claim 2, wherein said first precursor is a silicon containing precursor, said second precursor is an oxygen containing precursor, and said precursor materials react to form silica particles.

5. A method of making an optical fiber preform in accordance with claim 3, further comprising depositing said silica particles on a substrate to form a soot preform.

6. A method of making an optical fiber preform in accordance with claim 4, further comprising depositing said silica particles on a substrate to form a soot preform.

7. The method of claim 5, further comprising heating said soot preform to a temperature sufficient to consolidate the soot preform.

8. The method according to claim 2 wherein said induction heating comprises a frequency insufficient to substantially form a plasma.

9. The method according to claim 5 wherein said contacting step further comprises contacting a dopant containing precursor with said first and second precusor materials, and said dopant comprises a compound having at least one element selected from the group of elements consisting F, Br, B, Bi, Cl, I, Ge, Sn, Pb, S, Se, Te, Ga, In, As, P, Sb, Ti, Ta, Al, alkalis (Li, Na, K, Rb, Cs, Be), alkaline earths (Mg, Ca, Sr, Ba), rare earths (Ce, Pr, Nd, Sm, Eu, Gd, Tb, Dy, Ho, Er, Tm, Yb, Lu), transition metals (elements 21-29 (scandium through cooper), elements 39-47 (ytterbium through silver), 57-79 (lanthanum through gold), and elements 89 et seq. (actinium through the end of the periodic table). Examples of potential dopant compounds include organometallics (such as alkoxides or “fods”), soluble salts and combinations thereof.

10. A method of forming an optical fiber preform comprising:
heating a silicon precursor to a first temperature of less than about 2000° C. in a first chamber;
heating an oxidizing component to a second temperature of less than about 2000° C. in a second chamber, said second chamber apart from said first chamber;
combining said heated silicon precursor and said heated oxidizing component to form a mixture;
maintaining said mixture at a third temperature above a temperature associated with an activation energy for said silicon precursor to react with said oxidizing component, wherein said third temperature comprises less than about 2000° C., to form said soot particle; and
depositing said soot particle on a starting member.

11. The method according to claim 10 wherein said maintaining occurs in a third chamber and further comprising introducing a shield gas through said third chamber to inhibit deposition of said soot particle on an inner surface of said third chamber.

12. The method according to claim 10 wherein at least one of said heating of said silicon precursor, said heating of said oxidizing component, said maintaining of said mixture, and combinations thereof comprise induction heating.

13. The method according to claim 10 wherein said silicon precursor further comprises a dopant.

14. The method according to claim 13 wherein said dopant comprises a compound having at least one element selected from the group of elements consisting of F, Br, B, Bi, Cl, I, Ge, Sn, Pb, S, Se, Te, Ga, In, As, P, Sb, Ti, Ta, Al, alkalis (Li, Na, K, Rb, Cs, Be), alkaline earths (Mg, Ca, Sr, Ba), rare earths (Ce, Pr, Nd, Sm, Eu, Gd, Tb, Dy, Ho, Er, Tm, Yb, Lu), transition metals (elements 21-29 (scandium through cooper), elements 39-47 (ytterbium through silver), 57-79 (lanthanum through gold), and elements 89 et seq. (actinium through the end of the periodic table). Examples of potential dopant compounds include organometallics (such as alkoxides or “fods”), soluble salts, and combinations thereof.

15. The method according to claim 10 wherein said oxidizing component comprises at least one compound selected from O₂, nitrous oxide, nitric oxide, ozone, and combinations thereof.

16. A soot particle forming apparatus comprising:
a first reactant delivery chamber;
a second reactant delivery chamber;
at least one heating element to supply heat to at least one of said first and second chambers;
a mixing chamber aligned to receive at least one reactant from each of said first and second chambers;
a formation chamber extending from said mixing chamber, said formation chamber further comprising an induction coil positioned along at least a portion of an exterior surface of said formation chamber.

17. The apparatus according to claim 16 wherein said heating element to supply heat to at least one of said first and second chambers comprises at least one induction coil.

18. The apparatus according to claim 17 wherein said heating element to supply heat to said first and second chambers comprises at least one induction coil positioned along at least a portion of an exterior surface of said first chamber and at least a second induction coil positioned along at least a portion of an exterior surface of said second chamber.

19. A method of forming an optical fiber soot comprising:
mixing a silicon precursor and oxidizing agent;
inductively heating a mixture of said silicon precursor and said oxidizing agent, in a chamber to a temperature at which said mixture forms a silica soot particle; and
depositing said particle on a starting member, wherein said starting member does not comprise a wall of said chamber.

20. The method of claim 19 wherein said mixture is substantially devoid of a fuel.

21. The method of claim 19 wherein a maximum temperature inside said chamber comprises less than about 2000° C.

22. The method of claim 19 further comprising heating said silicon precursor to a temperature of at least about 100° C. prior to said mixing.
